(19) United States
(12) Patent Application Publication
(10) Pub. No.: US 2026/0084224 A1
(43) Pub. Date: Mar. 26, 2026

(54) GUIDE DEVICE FOR DRILLING TOOL

(71) Applicant: Chevron Tool Co., Ltd., TAICHUNG CITY (TW)

(72) Inventors: Ming-Hui CHEN, TAICHUNG CITY (TW); Ching-Ling LAI, TAICHUNG CITY (TW)

(21) Appl. No.: 18/894,626

(22) Filed: Sep. 24, 2024

(51) Int. Cl. B23B 47/28

(52) U.S. Cl. CPC B23B 47/287

(57) ABSTRACT

A guide device for a drilling tool is provided, wherein the guide device includes: a main body including a first side, a second side and at least one guide hole extending through the first side and the second side, the second side including at least one attachment portion, the at least one guide hole including at least one inclined surface; and at least one adhesive member disposed on the at least one attachment portion and configured to be reusably adhered to a workpiece.

### BACKGROUND OF THE INVENTION

### Field of the Invention

The present invention relates to a guide device, particularly to a guide device for drilling tool.

### Description of the Prior Art

A drilling guide device is a tool used to assist users in precisely drilling holes on a workpiece. A conventional drilling guide device includes a main body with guide holes thereon, wherein the guide holes are used to guide the drilling tool during the drilling operation.

However, when using a drilling guide device, the user typically needs to hold the drilling guide device with one hand while operating the drilling tool with the other hand. This operation not only increases the user's burden but can also result in unstable drilling, especially when long periods of operation are required.

Furthermore, when the drilling guide device guides the drilling tool at an angle into the guide hole, it can easily cause wear to the guide hole. Therefore, conventional drilling guide devices have problems such as short service life and inconvenient operation.

The present invention is, therefore, arisen to obviate or at least mitigate the above-mentioned disadvantages.

### SUMMARY OF THE INVENTION

The main object of the present invention is to provide a guide device for a drilling tool, which can be reusably adhered to a workpiece for positioning, thereby facilitating auxiliary drilling and being resistant to wear.

To achieve the above and other objects, a guide device for a drilling tool is provided, wherein the guide device includes: a main body including a first side, a second side and at least one guide hole extending through the first side and the second side, the second side including at least one attachment portion, the at least one guide hole including at least one inclined surface; and at least one adhesive member disposed on the at least one attachment portion and configured to be reusably adhered to a workpiece.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a front view of an exemplary embodiment of the present invention;

FIG. 4 is a schematic view showing a guide device adhered to a workpiece according to an exemplary embodiment of the present invention adhered to a workpiece;

FIG. 5 is a cross-sectional view taken along line A-A of FIG. 4;

FIG. 6 is an enlarged partial view of FIG. 5;

FIG. 7 is a drawing showing the guide device in use according to an exemplary embodiment of the present invention;

FIG. 8 is a drawing showing the guide device in another state in use according to an exemplary embodiment of the present invention;

FIG. 9 is a cross-sectional view of FIG. 8;

FIG. 10 is a drawing showing the guide device in another state in use according to an exemplary embodiment of the present invention; and

FIG. 11 is a drawing showing the guide device in another state in use according to an exemplary embodiment of the present invention.

### DETAILED DESCRIPTION OF THE PREFERRED EMBODIMENTS

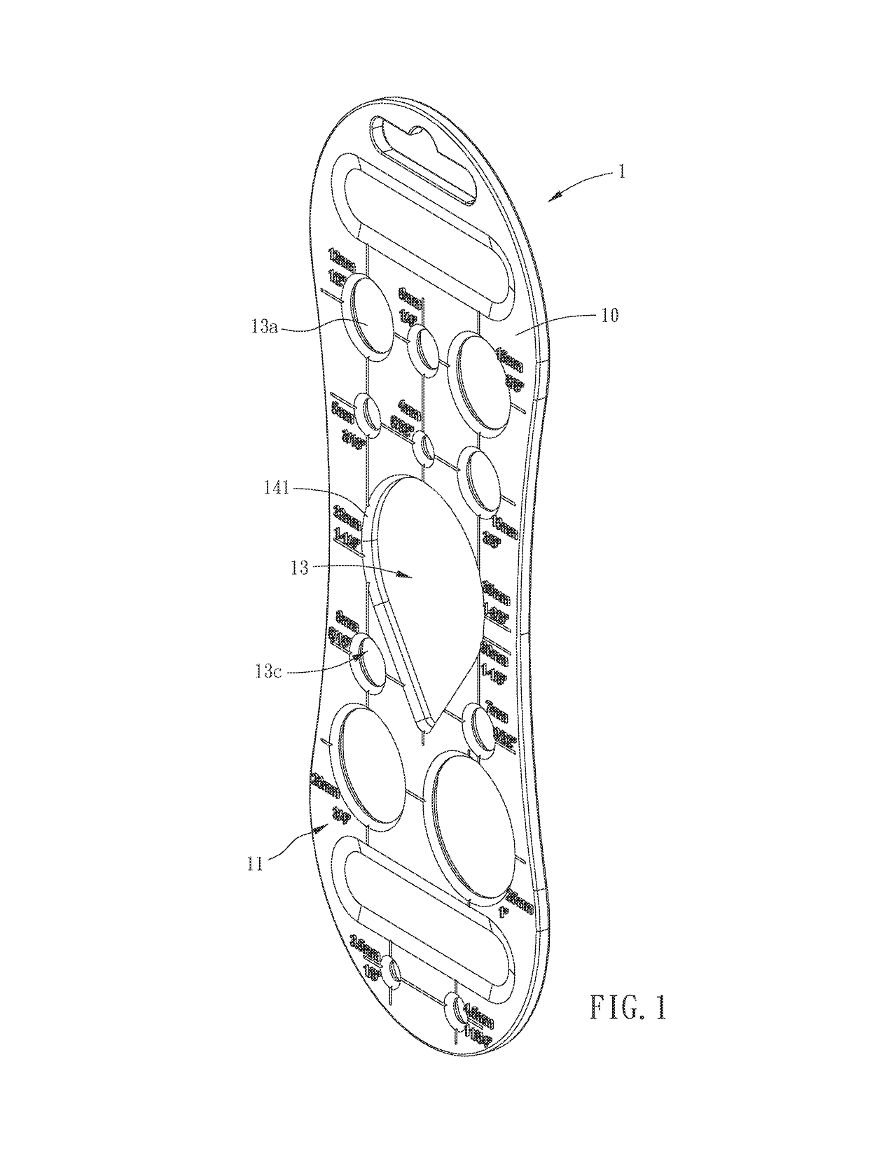

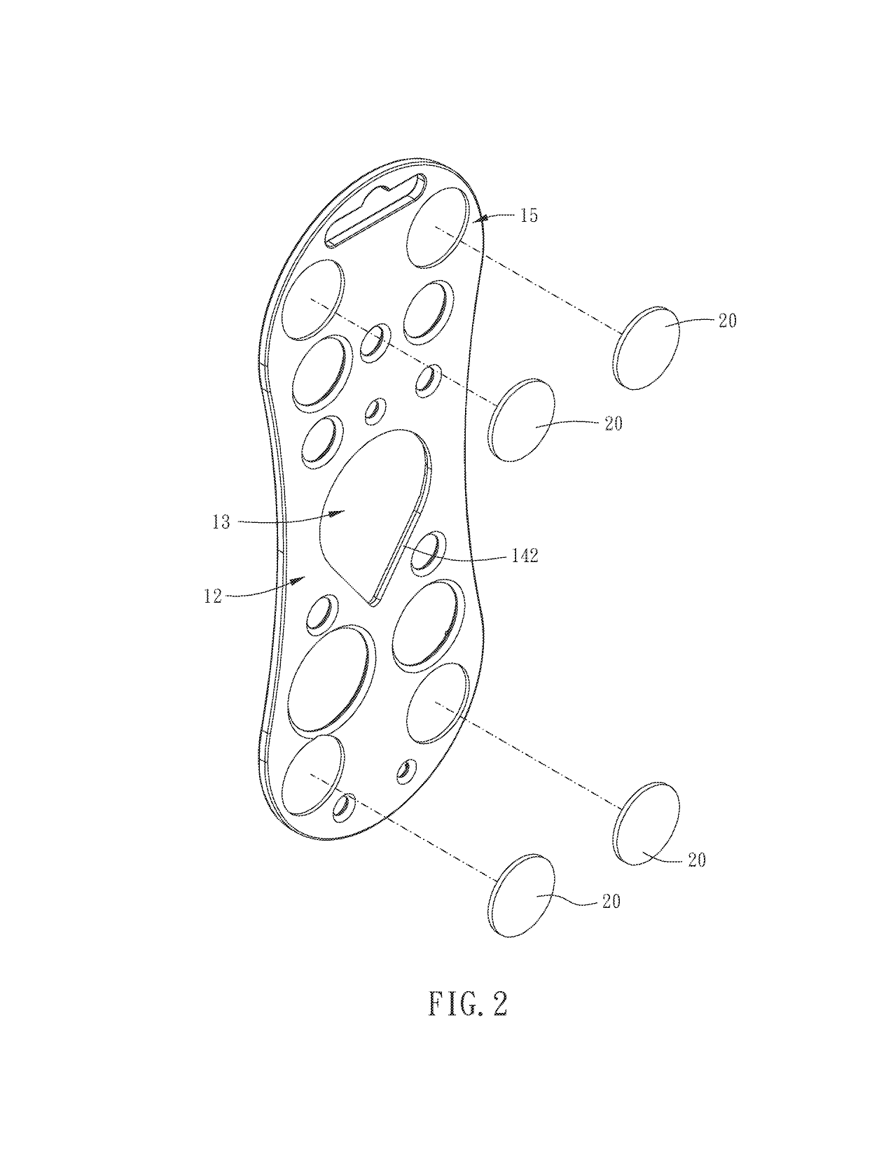

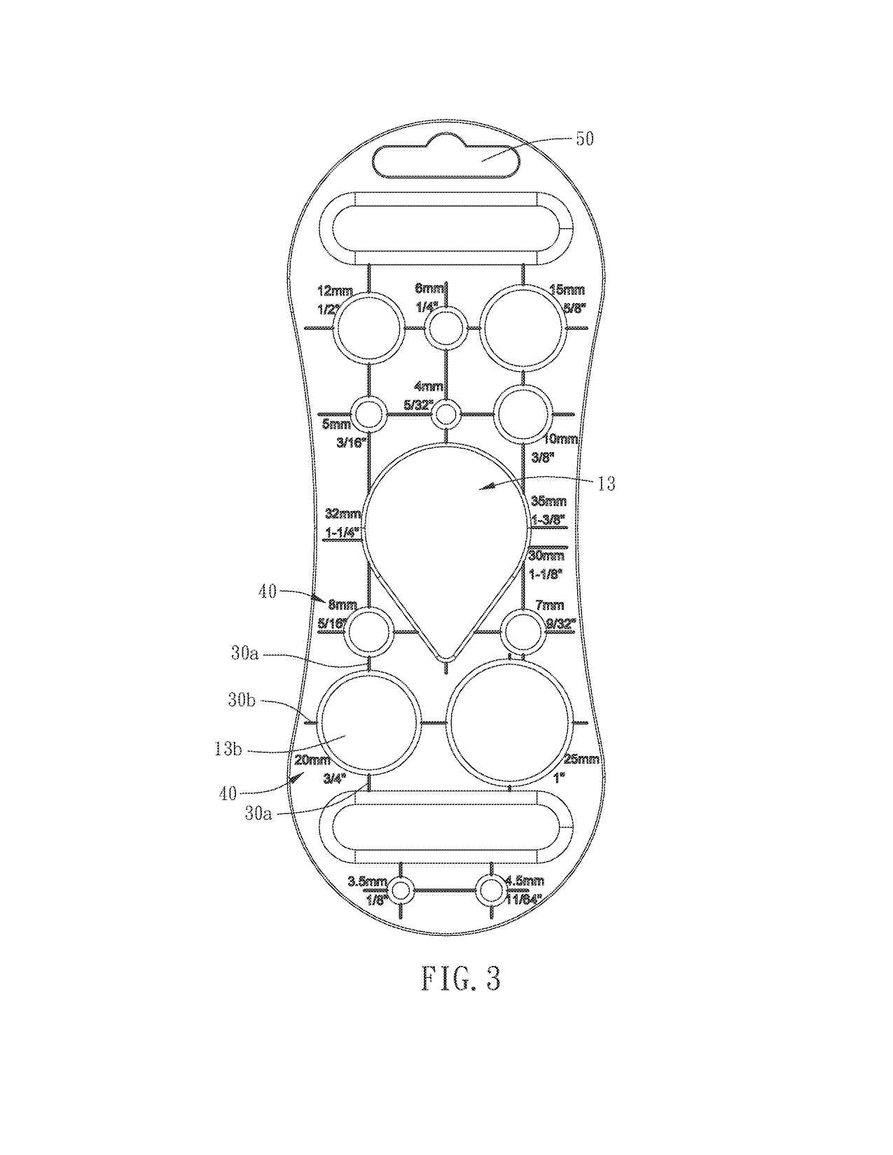

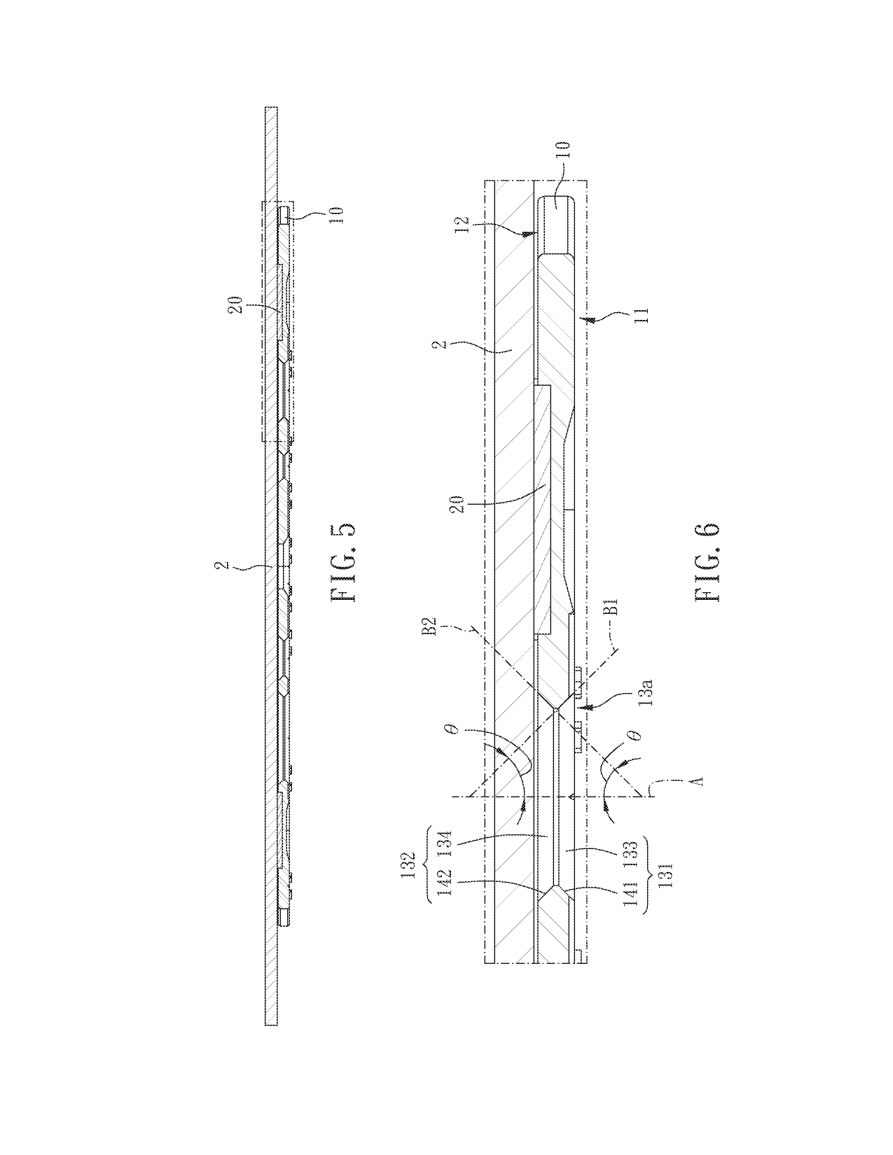

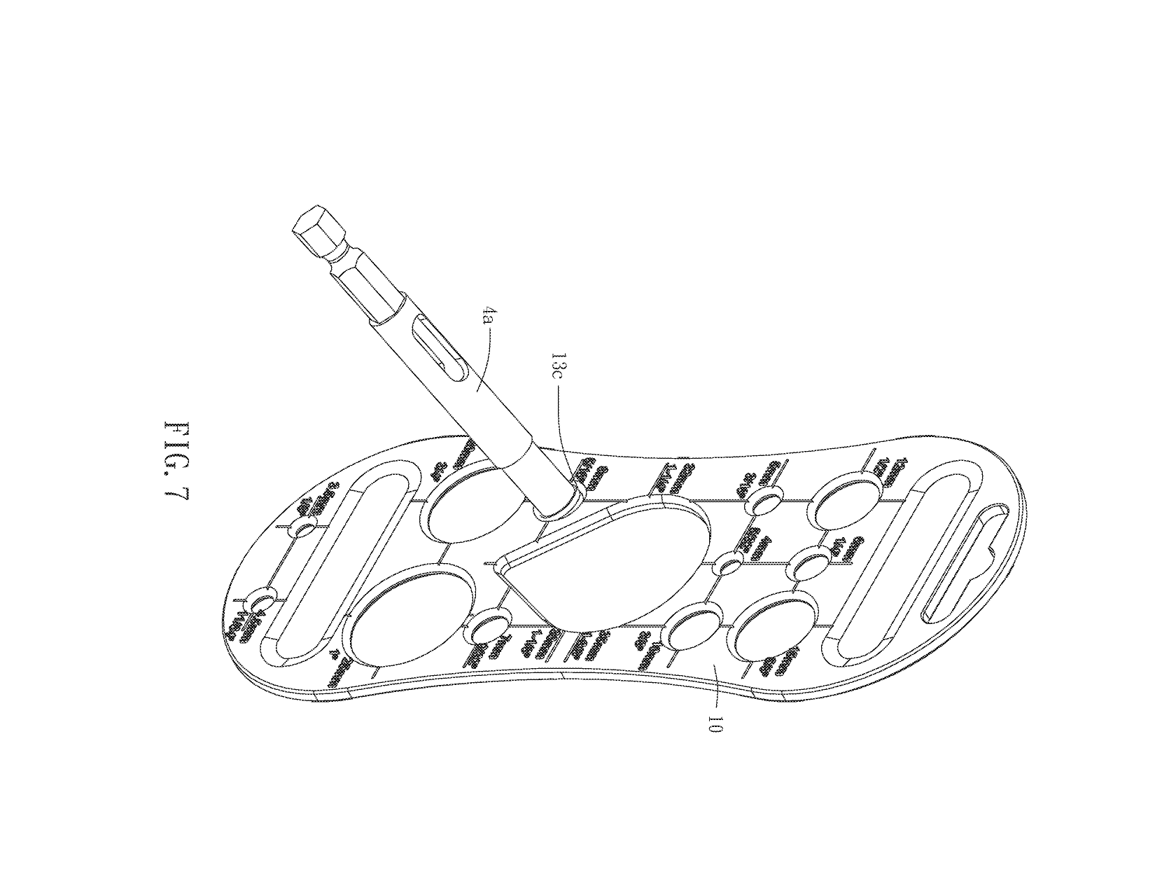

Please refer to FIGS. 1 to 11 for an exemplary embodiment of the present invention. A guide device 1 of the present invention includes a main body 10 and at least one adhesive member 20.

The main body 10 includes a first side 11, a second side 12, and at least one guide hole 13, 13a, 13b, 13c extending through the first side 11 and the second side 12. The second side 12 includes at least one attachment portion 15. The at least one guide hole 13, 13a, 13b, 13c includes at least one inclined surface. The at least one adhesive member 20 is disposed on the at least one attachment portion 15 and is configured to be reusably adhered to a workpiece 2 which is the piece to be drilled.

The guide device 1 can be reusably adhered to the workpiece 2 for repeated adhesion, allowing the user to free both hands to operate a drilling tool 4a, 4b, 4c, 4d (including a tool such as a hole saw, but not limited to), so that it facilitates stable drilling. Additionally, the at least one inclined surface can make it less likely for the main body 10 to be worn when the drilling tool 4a, 4b, 4c, 4d is introduced at an angle into the at least one guide hole 13, 13a, 13b, 13c and rotates at an angle within the at least one guide hole 13, 13a, 13b, 13c.

The main body 10 is a plate member.

The first side 11 and the second side 12 are located on opposite sides of the main body 10. The at least one attachment portion 15 is protrusive beyond the second side 12. Preferably, the guide device 1 includes a plurality of adhesive members 20 spaced apart from one another, and the second side 12 includes a plurality of attachment portions 15. The plurality of adhesive members 20 are disposed on the plurality of attachment portions 15 respectively, and the at least one guide hole 13, 13a, 13b, 13c is located between the plurality of attachment portions 15. As such, each of the plurality of adhesive members 20 can be positioned stably, reducing the likelihood of sliding or detachment from the main body 10 due to the rotational force of the drilling tool 4a, 4b, 4c, 4d. Moreover, each of the plurality of adhesive members 20 can distribute the force and provide stable positioning effect.

Each of the plurality of adhesive members is a washable and reusable adhesive, allowing the guide device 1 to be washed directly with water, and each of the plurality of adhesive members can be reused after cleaning.

Each guide hole 13, 13a, 13b, 13c defines a central axis A extending axially and defines an extension line B1, B2 passing through the at least one inclined surface (first inclined surface 141, second inclined surface 142, and inclined guide surface 143) and extending along the at least one inclined surface. The at least one inclined surface extends around the central axis A, and an included angle θ is defined between the central axis A and the extension line B1, B2. The included angle θ ranges from 30.00 degrees to 65.00 degrees (preferably 45.00 degrees or 60.00 degrees), and thus it less likely for the main body 10 to be worn during inclined guiding and rotational inclined operations of the drilling tool 4a, 4b, 4c, 4d.

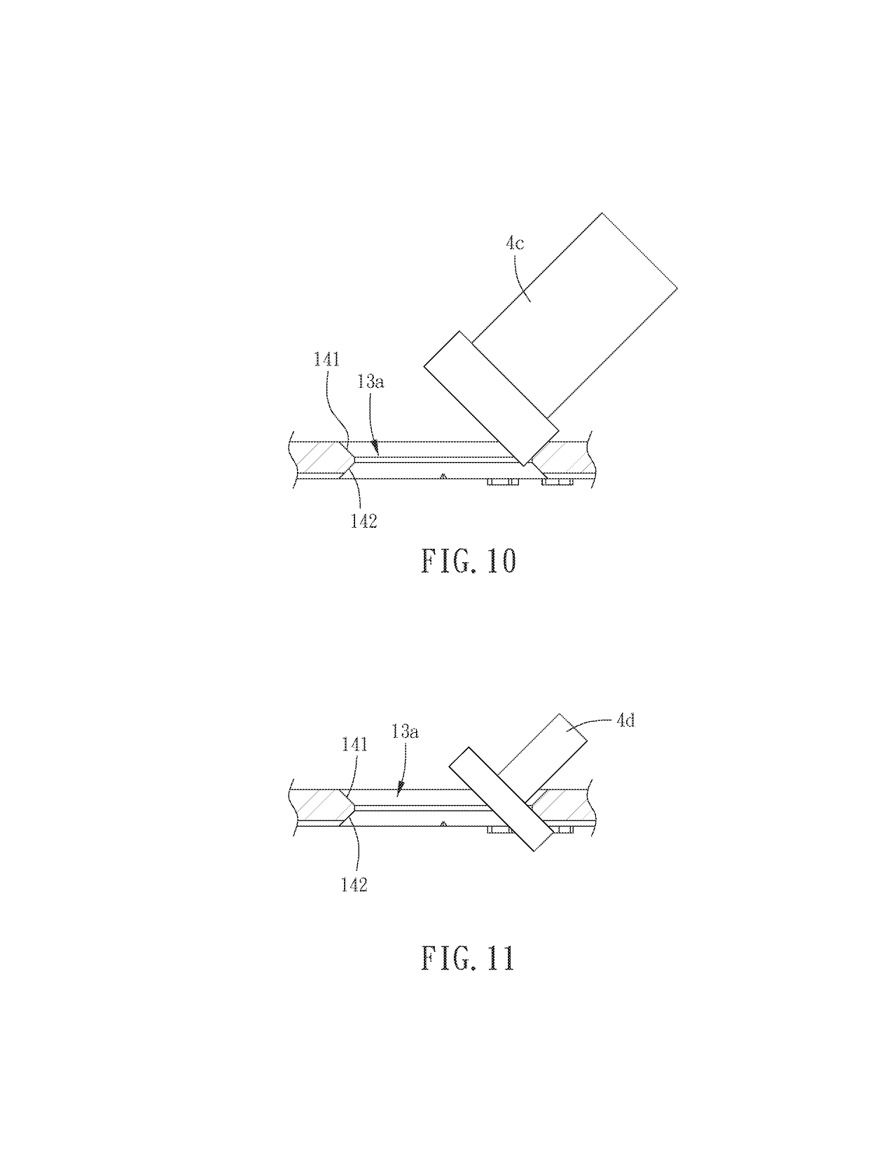

With the first hole section 131 and the second hole section 132 extending in opposite directions, different machining needs can be met. For example, as shown in FIG. 10, the first inclined surface 141 of the first hole section 131 provides a larger aperture to allow the drilling tool 4c to incline into the workpiece (such as for creating a guiding positioning groove) while preventing wear on the main body 10. Additionally, as shown in FIG. 11, when the drilling tool 4d is, for example, a brazed diamond grinding wheel, the second inclined surface 142 can prevent wear during drilling. However, it is not limited thereto, as the brazed diamond grinding wheel, with varying proportions, can avoid wear on the main body 10 when inclined within the guide holes 13, 13a, 13b, 13c.

In other embodiments, each guide hole may include only a single inclined surface, and each guide hole gradually expands and is open toward the first side. In yet another embodiment, each guide hole may include only a single inclined surface, and each guide hole gradually expands and is open toward the second side. As such, it is allowed to receive different drilling tools and drilling requirements such as forward drilling and reverse drilling.

Each guide hole 13, 13a, 13b, 13c includes a plurality of inclined surfaces, including a first inclined surface 141 and a second inclined surface 142. The at least one guide hole 13, 13a, 13b, 13c has a first hole section 131 and a second hole section 132 located on opposite sides along the axial direction, and the first hole section 131 and the second hole section 132 are in communication with each other. The first hole section 131 includes a first hole 133 and the first inclined surface 141 surrounding the first hole 133 open towards the first side 11. The second hole section 132 includes a second hole 134 and the second inclined surface 142 surrounding the second hole 134 open towards the second side 12. Preferably, the first inclined surface 141 and the second inclined surface 142 extend around the central axis A, and the first inclined surface 141 and the second inclined surface 142 gradually expand axially in opposite directions.

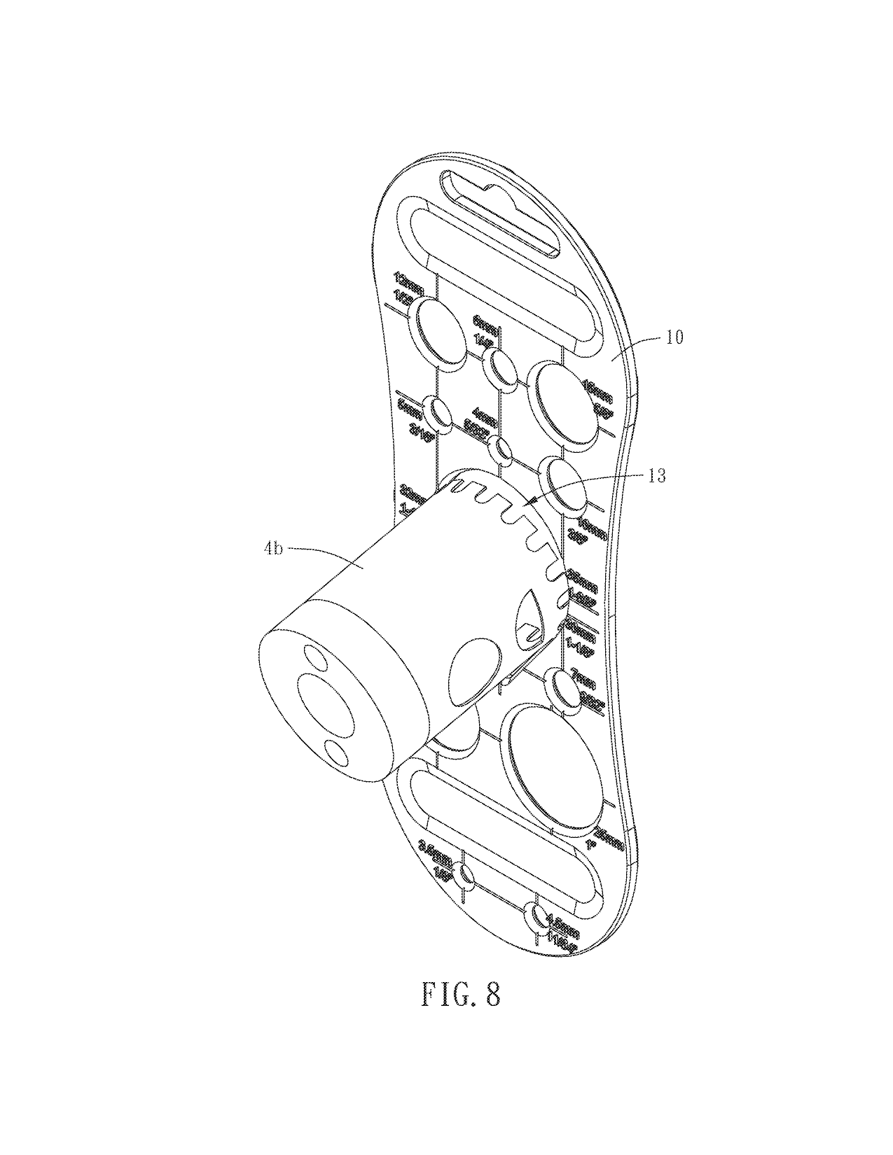

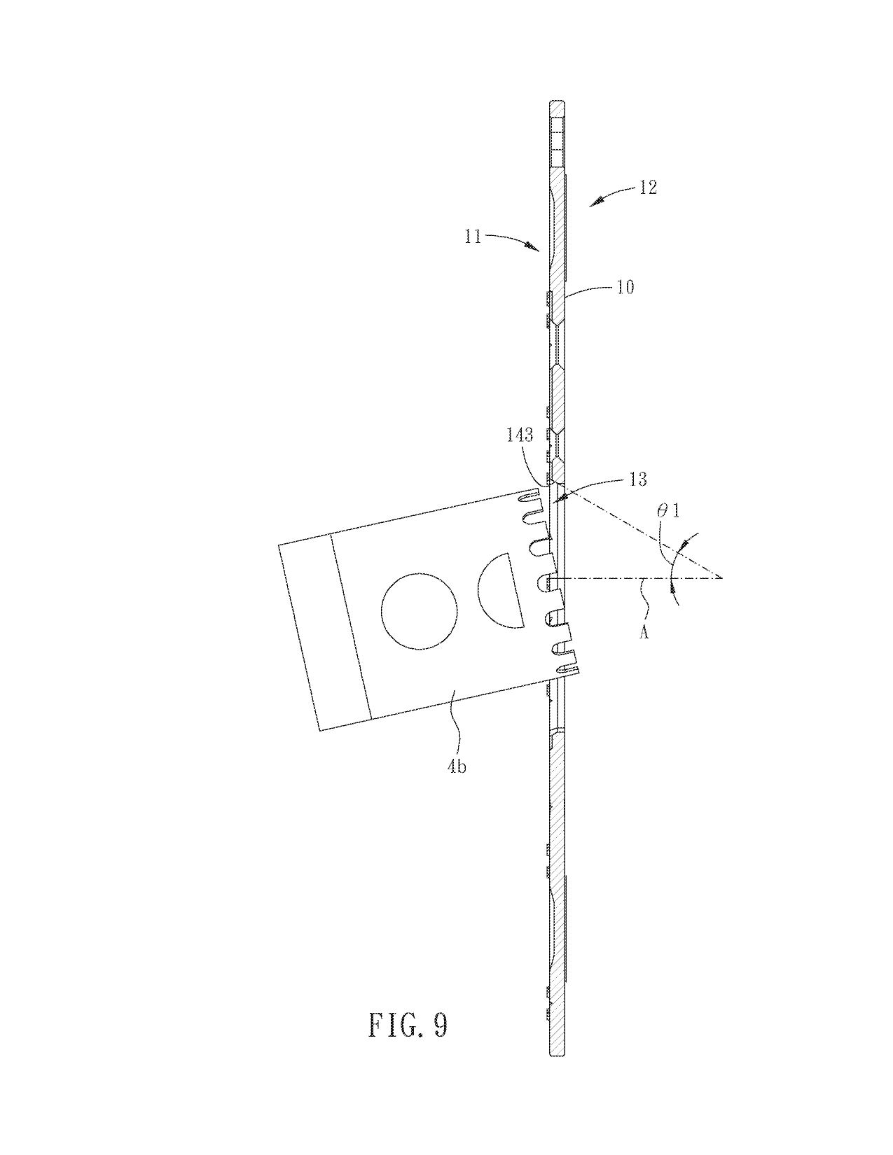

Preferably, the at least one guide hole 13 is teardrop-shaped. Please refer to FIGS. 8 and 9, the included angle θ1 between the inclined surface (inclined guide surface 143) and the central axis A ranges from 30 degrees to 60 degrees (preferably 45 degrees). With the included angle of 45 degrees and a teardrop shape, it can effectively guide the drilling tools 4a, 4b, 4c, 4d to incline into the workpiece and prevent wear on the main body 10 after the drilling tools 4a, 4b, 4c, 4d are stabilized, thereby providing a long service life.

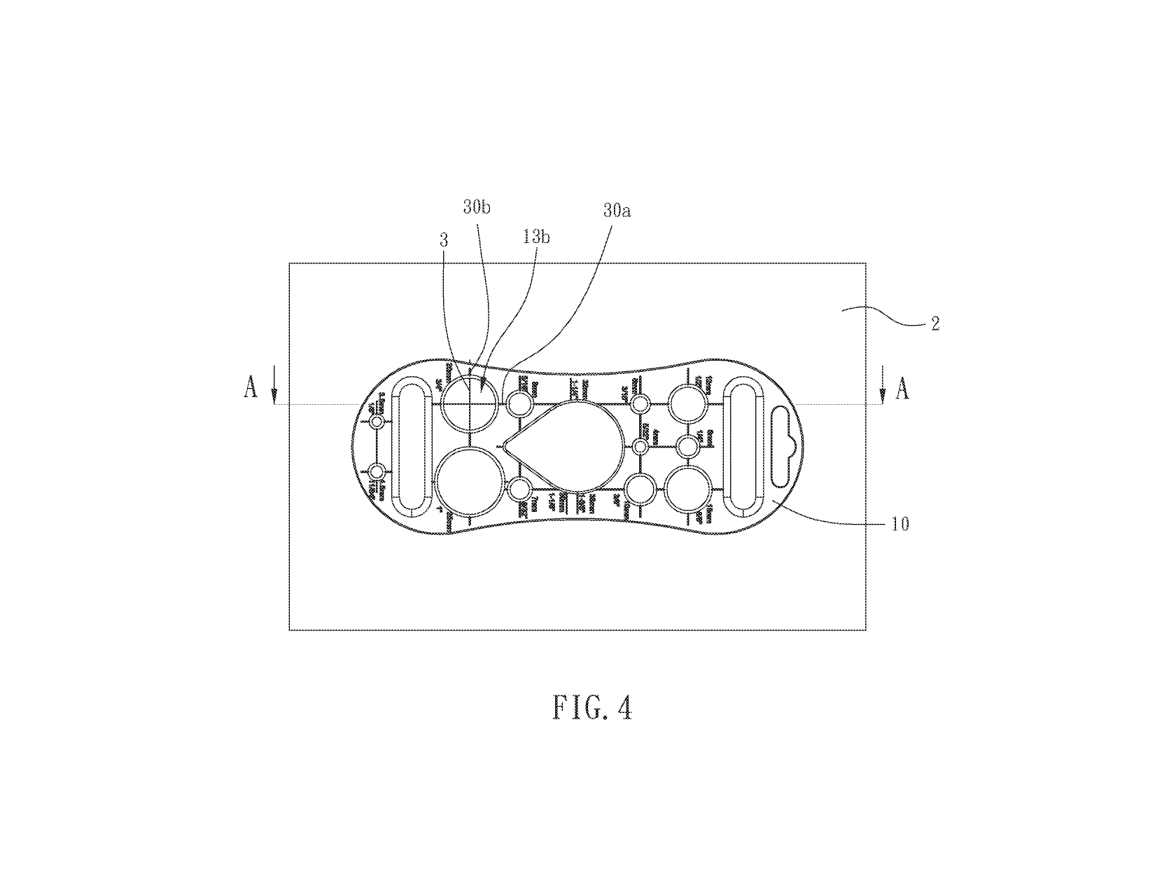

The first side 11 includes a plurality of reference marks 30a, 30b extending linearly thereon. Each of the reference marks 30a, 30b extends radially outward from the at least one guide hole 13, 13a, 13b, 13c. At least two of the reference marks 30a, 30b extend transversely to each other. As shown in FIG. 4, at least four of the reference marks 30a, 30b are aligned with a cross mark 3 on the workpiece 2, allowing for the precise positioning of the guide hole 13c on the workpiece 2.

The main body 10 includes a plurality of guide holes 13, 13a, 13b, 13c, and at least two of the guide holes 13, 13a, 13b, 13c are of different sizes. The first side 11 includes a plurality of size marks 40, and each size mark 40 is positioned adjacent to at least one of the guide holes 13, 13a, 13b, 13c. The size indicated by each size mark 40 corresponds to the size of the adjacent guide hole 13, 13a, 13b, 13c, which facilitates the user's quick identification of the guide hole sizes.

Preferably, the main body 10 further includes a hanging hole 50, which allows the guide device 1 to be hung on a peg or the like for storage.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A guide device for a drilling tool including:
a main body including a first side, a second side and at least one guide hole extending through the first side and the second side, the second side including at least one attachment portion, the at least one guide hole including at least one inclined surface; and
at least one adhesive member disposed on the at least one attachment portion and configured to be reusably adhered to a workpiece.

2. The guide device of claim 1, wherein the first side and the second side are located on opposite sides of the main body, and the at least one adhesive member is protrusive beyond the second side.

3. The guide device of claim 1, wherein each of the at least one guide hole defines a central axis extending axially and defines an extension line passing through the at least one inclined surface and extending along the at least one inclined surface, the at least one inclined surface extends around the central axis, an included angle is defined between the central axis and the extension line, and the angle ranges from 30.00 degrees to 65.00 degrees.

4. The guide device of claim 1, wherein the at least one guide hole defines a central axis extending axially, each of the at least one guide hole includes a plurality of inclined surfaces, each of the plurality of inclined surfaces includes a first inclined surface and a second inclined surface, the at least one guide hole has a first hole section and a second hole section located on opposite sides along the axial direction, the first hole section includes a first hole and the first inclined surface surrounding the first hole open towards the first side, and the second hole section including a second hole and the second inclined surface surrounding the second hole open towards the second side.

5. The guide device of claim 4, wherein the first inclined surface and the second inclined surface extend around the central axis, and the first inclined surface and the second inclined surface expand axially in opposite directions.

6. The guide device of claim 1, wherein the at least one adhesive member includes a plurality of adhesive members spaced apart from one another, the at least one attachment portion includes a plurality of attachment portions, the plurality of adhesive members are disposed on the plurality of attachment portions respectively, and the at least one guide hole are located between the plurality of attachment portions.

7. The guide device of claim 1, wherein the first side includes a plurality of reference marks extending linearly thereon, each of the plurality of reference marks extends radially outward from the at least one guide hole, and at least two of the plurality of reference marks are transverse to each other.

8. The guide device of claim 1, wherein each of the at least one adhesive member is a washable and reusable adhesive.

9. The guide device of claim 1, wherein the at least one guide hole is teardrop-shaped.

10. The guide device of claim 5, wherein the first side and the second side are located on opposite sides of the main body, and the at least one adhesive member is protrusive beyond the second side; each of the at least one guide hole defines a central axis extending axially and defines an extension line passing through the at least one inclined surface and extending along the at least one inclined surface, the at least one inclined surface extends around the central axis, an included angle is defined between the central axis and the extension line, and the angle ranges from 30.00 degrees to 65.00 degrees; the at least one guide hole is teardrop-shaped; the first side includes a plurality of reference marks extending linearly thereon, each of the plurality of reference marks extends radially outward from the at least one guide hole, and at least two of the plurality of reference marks are transverse to each other; each of the at least one adhesive member is a washable and reusable adhesive; the main body is a plate member; the at least one adhesive member includes a plurality of adhesive members spaced apart from each other, the at least one attachment portion includes a plurality of attachment portions, the plurality of adhesive members are disposed on the plurality of attachment portions respectively, and the at least one guide hole are located between the plurality of attachment portions; the first side includes a plurality of size marks, and each of the plurality of size marks is located adjacent to at least one of the plurality of guide holes; the main body further includes a hanging hole; the at least one guide hole includes a plurality of guide holes, and at least two of the plurality of guide holes are of different sizes.
